(19) United States
(12) Patent Application Publication
(10) Pub. No.: US 2012/0023100 A1
(43) Pub. Date: Jan. 26, 2012

(54) METHOD AND APPARATUS FOR CHANGING REFERENCES BETWEEN OBJECTS

(75) Inventor: Kunio Kamimura, TOKYO (JP)

(73) Assignee: ATHENA TELECOM LAB, INC., TOKYO (JP)

(21) Appl. No.: 13/251,295

(22) Filed: Oct. 3, 2011

Related U.S. Application Data
(63) Continuation-in-part of application No. 12/688,854, filed on Jan. 15, 2010.
Application No. 12/688,854 is a continuation-in-part of application No. 12/601,005, filed on Apr. 13, 2010.
Application No. 12/601,005 is a continuation-in-part of application No. 12/864,872, filed on Nov. 18, 2010.

(30) Foreign Application Priority Data
Jun. 6, 2007 (JP) JP2007-150665

(51) Int. Cl. G06F 17/30

(52) U.S. Cl. 707/736; 707/E17.055

(57) ABSTRACT

Presented is a method and an apparatus that change references between computer-objects that are memory blocks. Purpose is to change all references to a specific computer-object, which is called current-destination-object, into another object, which is called next-destination-object. For this purpose, information showing the next-destination-object, which is called as order-information, is attached to the current-destination-object. Reference of each computer-object is changed by tracing these computer-objects, references and order-information in order of the followings: A source-object, reference held by the source-object, next-destination-object indicated by the reference, and order-information (showing the next-destination-object) that is attached to the current-destination-object. Finally, the reference is changed so as to indicate the new destination object.

### CROSS-REFERENCE TO RELATED APPLICATIONS

This application is a continuation-in-part of U.S. application Ser. No. 12/688,854. The following pending US Applications relate to the present application. U.S. application Ser. No. 12/601,005 that is a U.S. National stage of PCT/JP2008/001424, U.S. application Ser. No. 13/024,330 that is a continuation-in-part of U.S. application Ser. No. 12/864,872, U.S. application Ser. No. 12/864,872 that is a continuation-in-part of PCT/JP2009/002491, U.S. application Ser. No. 12/995,158 that is a U.S. National stage of PCT/JP2009/002490 and U.S. application Ser. No. 12/743,367 that is a U.S. National stage of PCT/JP2009/002501. Entire contents of these six U.S. application Ser. Nos. 12/688,854, 12/601,005, 13/024,330, 12/864,872, 12/995,158 and 12/743,367 are herein incorporated by reference.

### BACKGROUND OF THE INVENTION

1. Computer-Object that is an Object used in Computer Science

An object-oriented programming language such as C++ handles an object that is a memory block defined by a class showing memory structure and functions. Other traditional computer programming languages such as C can do substantially same as C++. C can use a memory block defined by a structure sentence showing logical structure of memory block. This memory block is an object. A record or data of the object-oriented database, relational database or any other kind of database is an object. These objects are not real objects of the real world, but are memory blocks that can be accessed by an apparatus having a function accessing logical blocks of memory.

This specification mainly uses a word “object”, as in usual documents of computer science. However, a word “computer-object” is used in claims, for avoiding confusion of persons who read only them. Both words, “object” and “computer-object”, have exactly same meaning in the present invention.

### 2. Reference Between Objects

An object “S” can be assigned data indicating another object “D”. Here, S means a source-object and D means a destination-object. The data is called as a pointer to D (from S), or as a reference to D (from S). A word of “reference” expresses a general concept of indicating the destination-object. For example, a memory address of the destination-object, a label assigned to the destination-object, a number assigned to the destination-object, a list of labels assigned to the destination-object (as shown by U.S. Pat. No. 6,526,455), or any other data indicating the destination-object, can be reference.

### 3. Problems of Traditional Methods

### 3.1 Situation Assumed and Traditional Method for Solving a Request

First, suppose that plural source-objects have references to a specific destination-object, which is called current-destination-object. Requested is that these references should be changed so as to refer to another specific object that is called next-destination-object.

Traditional method solving the request is the following. Checked is every object that may have a reference to the current-destination-object. During the checking, each reference to current-destination-object is changed so as to indicate next-destination-object.

### 3.2 Problem One

If very many objects have possibility to have references to current-destination-object, checking all these objects requires huge processing load and time.

### 3.3 Additional Situation Assumed

Further, suppose that plural computers have duplicates of these objects and edit them independently, which is called “simultaneous-editing-work”. That is to say, objects are copied to each computer having possibility to perform simultaneous-editing-work, by which each computer edits each duplicates without communicating with other computers. Simultaneous-editing-work is useful if communications are not stable such as mobile communication, if no communications are available such as under disaster situation, or if there is necessity to restrict volume of communication traffic.

### 3.4 Problem Two

Under the situation of section 3.1 and 3.3, the traditional method has another problem. All computers have to immediately check every object that may have references to current-destination-object, when some computer changed a reference. During this checking, all references to current-destination-object should be changed so as to indicate next-destination-object.

These processes can be implemented, only when all related computers are closely connected by communications links and immediately perform a procedure requested by other computers. It is impossible to implement them, if communications are not stable or no communications are available.

If these computers are connected through Internet, there will be very many packets that should be transmitted immediately among them.

### SUMMARY OF THE INVENTION

### 4. Apparatus and Method

FIG. 1 diagrams apparatus and method of the present invention. Apparatus 0101 of the present invention is consisting of a memory device 0107 and a means 0102. The memory device 0107 can be divided into plural number of devices. References recorded in the memory device 0107 will be changed by the means 0102 of handling 0114 (accessing and manipulating) objects.

The memory device 0107 contains source-object 0108, current-destination-object 0110 and next-destination-object 0112. The source-object 0108 has a reference 0109 indicating current-destination-object 0110. The current-destination-object 0110 is with information 0111 of showing next-destination-object 0112. Namely, the information 0111 (that is called as order-information) is expressing an order to alter the reference so as to indicate the next-destination-object.

The procedure performed by the means 0102, is containing the following steps,
(Step-1) a step 0103 of accessing source-object 0108 and reference 0119,
(Step-2) a step 0104 of accessing current-destination-object 0110 that is indicated by the reference 0109.
(Step-3) a step 0105 of accessing order-information 0111, and
(Step-4) a step 0106 of changing 0113 the reference 0109 so as to indicate next-destination-object 0112, according to the order-information 0111.

Methods (claims 3 to 6) of the present invention are procedures to be performed by the means 0102.

### 5. Changing References by the Invention

FIG. 2 shows an example of changing references. At (1) of FIG. 2, Object (a) and Object (b) refer to Object (c) that is the current-destination-object. This is the initial state.

Next, decided is changing these references so as to indicate Object (d) that is the next-destination-object. Order-information of showing the next-destination-object (which is Object (d)) is set to Object (c), as shown at (2) of FIG. 2.

When Object (a) is accessed and Object (c) is accessed according to the reference, the order-information of showing Object (d) is accessed. According to the order-information, the reference of Object (a) is changed so as to indicate Object (d) that is the next-destination-object, as shown at (3) of FIG. 2. When Object (b) is accessed and Object (c) is accessed according to the reference, the order-information of showing Object (d) is accessed. According to the order-information, the reference of Object (b) is changed so as to indicate Object (d) that is the next-destination-object, as shown at (4) of FIG. 2.

All references to Object (b) have been changed so as to indicate Object (d), as shown (5) of FIG. 2.

### 6. Resolution of the Problems

When accessing the source-object 0108 with a reference 0109 indicating the current-destination-object 0110, this reference 0109 will be changed so as to indicate the next-destination-object 0112. Even if very many objects have possibility to have references to the current-destination-object 0110, there is no need to check all of them immediately after decision of changing these references. There is no concentrated load of processing. The problem one has been solved.

Even if plural computers have duplications of objects and edit them independently (that is simultaneous-editing-work), the necessary task immediately after the decision to change a reference is the following. That is setting order-information 0111 showing next-destination-object 0112 to the current-destination-object 0110. This setting of order-information 0111 to the current-destination-object will be notified to other computers, and will be set to all copies of the current-destination-object 0110.

This spreading of the order-information over related computers can be performed by various methods. One method is sending the order-information to other computers directly. Another method is sending the order-information to other computers through a server computer, as shown in U.S. application Ser. No. 12/864,872. The present invention is not limited to a specific method of exchanging information among computers.

This order-information 0111 will be used to change references of copied objects in each computer. These changed references can be notified to all computers, by various methods as described above.

Thus, the problem two has been solved, too.

### BRIEF DESCRIPTION OF THE DRAWINGS

FIG. 1 shows apparatus and method.

FIG. 2 shows example of changing references.

FIG. 3 shows various implementations of objects.

FIG. 4 shows typical structure of a computer with average functions.

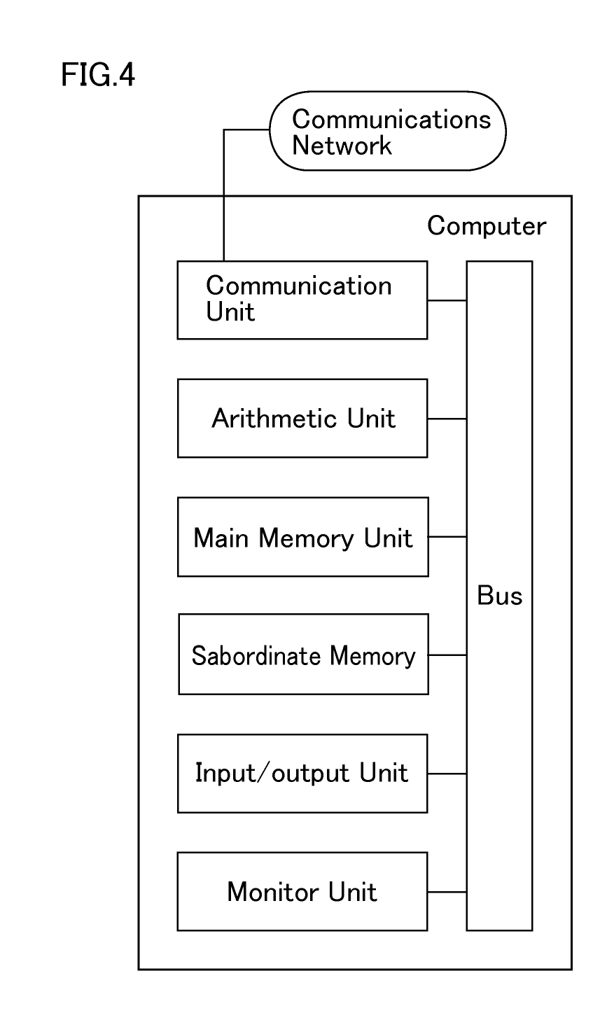

FIG. 5 shows various implementations of associations between objects and references.

FIG. 6 shows various implementations of associations between objects and order-information.

FIG. 7 shows sub-steps of step-4.

### DETAILED DESCRIPTION OF THE INVENTION

### 7. Technical Scope and Implementations

### 7.1 Computer-Object

At section 1, computer-object was explained as an object of computer science. Memory blocks defined by classes or by structures were shown as example of computer-objects. Though class and structure are terminology of C++ and C, computer-object of any object-oriented software is a logical block of information contained in a memory.

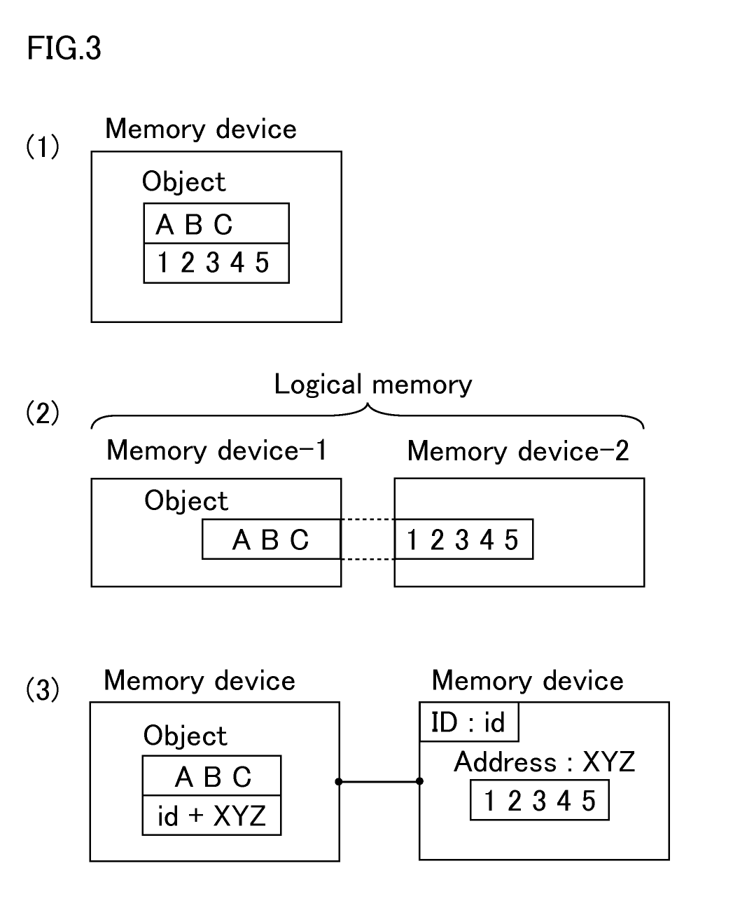

This collection of information is not limited to a single memory device . The (1) of FIG. 3 shows an object in a single memory block. The (2) of FIG. 3 shows an object in a single logical memory that is constructed by two memory devices. They are usual situation in ordinary computers.

The (3) of FIG. 3 shows an object gathering information of different memory devices which may be in different machines. Object of (3) is composing of character string “ABC”, and ID (IP address, MAC address, and so on) of another memory device plus address XYZ of the memory holding number “12345”. Object of (3) expresses logically same contents with objects of (1) and (2).

### 7.2 Apparatus Equivalent to a Computer

Claims use the phrase “an apparatus for handling computer-objects”. Intuitively saying, this apparatus can be conceived as an apparatus equivalent to a computer. Method of the present invention can be implemented as a computer program, which is loaded by a computer or apparatus equivalent to a computer and is performed.

From another view point, it is possible to say the following. A computer (or apparatus equivalent to a computer) can be reconfigured as the apparatus of the present invention by loading the program. Apparatus described in the claims (and in this specification) is equivalent to any kinds of computers (for example, personal computer, micro-processor, server machine, supercomputer, and so on), cellular phone, smart phone, hardware with wired logic, and any other apparatuses equivalent to them.

Please note that “an apparatus equivalent to a computer” does not mean apparatus having functionality of full equipped computer. There are many poor equipped computers such as micro-processor, hardware with wired logic and equivalent hardware. Required minimum function for implementing the present invention is to handle computer-objects. For avoiding unexpected misunderstanding, claims of the present invention use the phrase “an apparatus for handling computer-objects”.

### 7.3 Kinds of Memory Device

Objects that will be manipulated by the apparatus can exist on various kinds of memory devices. Some examples of memory devices are main memory (RAM), secondary memory (HDD, SSD or others), auxiliary or external memory (FD, RW-DVD, Blu-Ray Disk or others), and any other kind of memory device.

### 7.4 Preamble of Claims 1 and 3

From sections 7.1, 7.2 and 7.3, the preamble of claim 1 is “an apparatus for handling computer-objects that are collections of information contained in single or plural memory devices”. Similarly, the preamble of claim 3 is “a method for handling computer-objects that are collections of information contained in single or plural memory devices”.

### 7.5 Memory Structures Expressed by Claim 1

Apparatus of claim 1 has memory devices that are:
a memory device containing a source-object,
said device or another device containing an order-information.
   Thus, two types of memory structure of the apparatus are expressed by claim 1. One structure is consisting of a single memory device, which contains the source-object and the order-information. Here, (1) or (2) that is one single logical memory, of FIG. 3 is assumed. Another structure is consisting of a memory device containing the source object, and another memory device containing the order-information. Here, (2), that has two memory devices, or (3) of FIG. 3 is assumed.
   7.6 Object Associated with a Reference

In claims 1 and 3, there is a phrase “a source-object that is a computer-object associated with a reference indicating a current-destination-object that is a computer-object”. There are many ways to set association between the source-object and the reference.

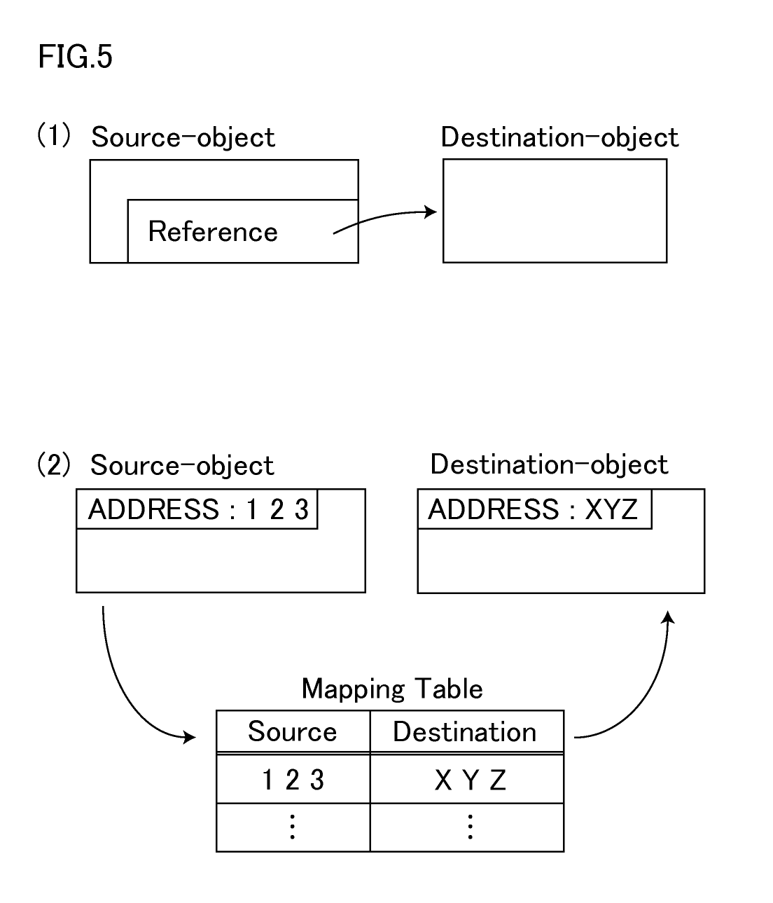

For example, case (1) of FIG. 5, the reference is written in the source-object. Here, the reference is a memory address of destination-object, a label assigned to destination-object, a number assigned to destination-object, a list of labels assigned to destination-object (as shown by U.S. Pat. No. 6,526,455), or any other data indicating destination-object.

Case (2) of FIG. 5 uses mapping table, in which memory addresses of source-address and destination-object are mapped. For finding destination-object from given source-object, address of source-object in the left side column of the mapping table should be identified. The corresponding value of the right side column is address of destination-object.

Each address of source-objects or destination-objects can be replaced by a label assigned to them, a number assigned to them, a list of labels assigned to them (as shown by U.S. Pat. No. 6,526,455), or any other data identifying them. Books of computer science show many other ways to set associations between them.

7.7 Order-Information Associated with Current-Destination-Object

In claims 1 and 3, there is a phrase “an order-information that is associated with said current-destination-object”. There are many ways to set association between the order-information and the current-destination-object.

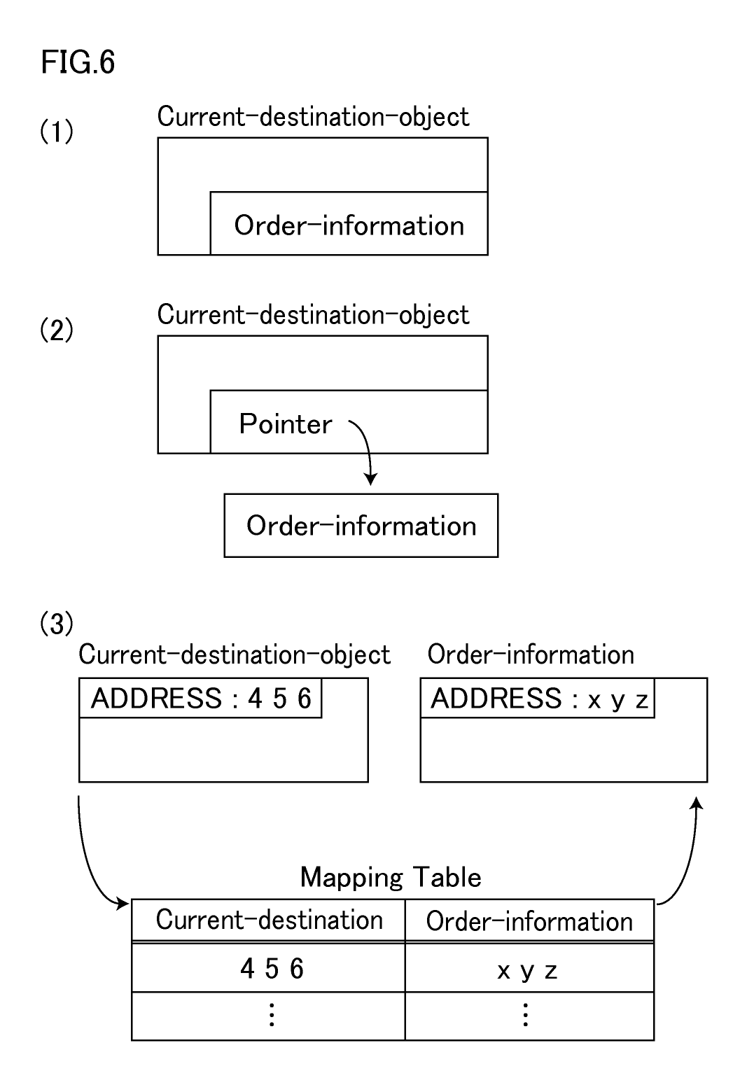

For example in case (1) of FIG. 6, the order-information is written in the current-destination-object.

In case (2) of FIG. 6, pointer to the order-information is written in the current-destination-object. Here, the pointer is a memory address of order-information, a label assigned to order-information, a number assigned to order-information, a list of labels assigned to order-information (as shown by U.S. Pat. No. 6,526,455), or any other data indicating order-information.

Case (3) of FIG. 6 uses mapping table, in which memory addresses of current-destination-object and order-information are mapped. For finding order-information from given current-destination-object, address of current-destination-object in the left side column of the mapping table should be identified. The corresponding value of the right side column is address of order-information.

Each address of current-destination-objects or order-information can be replaced by a label assigned to them, a number assigned to them, a list of labels assigned to them (as shown by U.S. Pat. No. 6,526,455), or any other data identifying them. Books of computer science show many other ways to set associations between them.

### 7.8 Additional Means

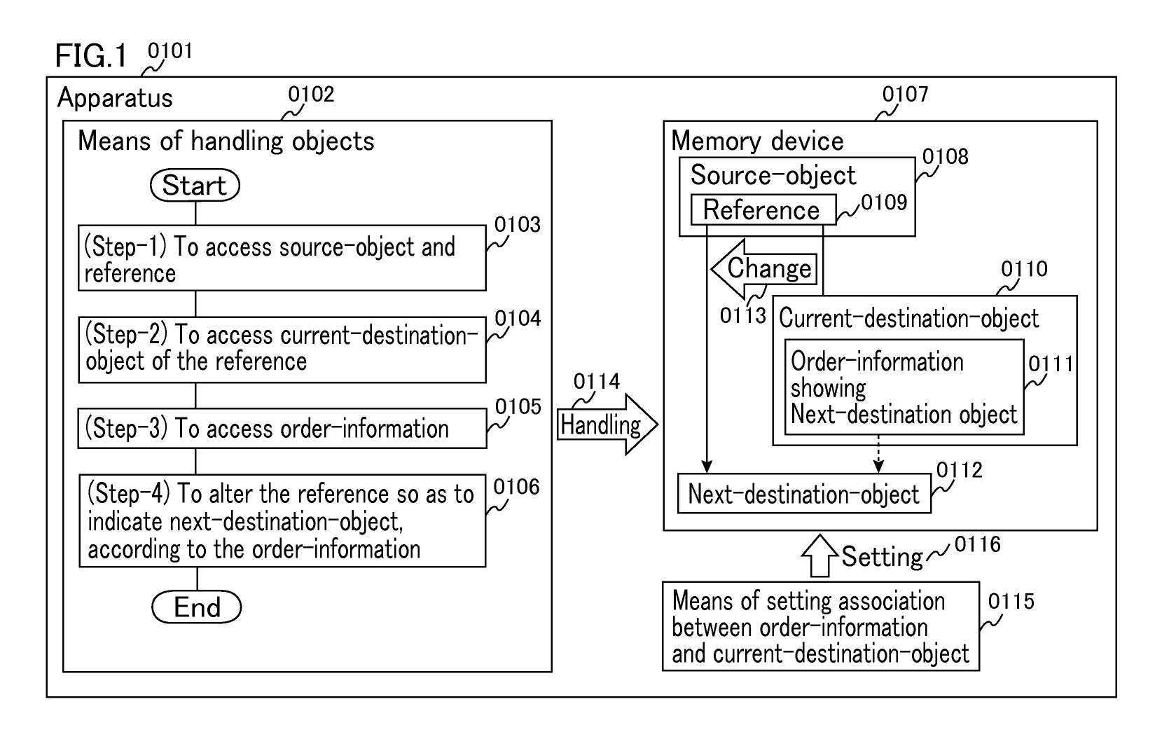

Apparatus of FIG. 1 can have an additional means 0115 that sets 0116 association between an order-information 0111 and a current-destination-object 0110. This is the claim 2.

### 7.9 Various Implementations of Step-4

### (1) Flag to be Treated as Deleted Object

Next-destination-object can have a flag showing that said next-destination-object is treated as a deleted object. When a reference is changed so as to indicate next-destination-object at Step-4, the flag can be changed so that said next-destination-object is treated as a non-deleted object. This is the claim 4.

Column named “Display” of Main Table A of FIG. 1 of U.S. application Ser. No. 12/688,854, which is a basis of continuation-in-part, shows Boolean value as non-deleted or deleted status.

### (2) Validity of Order-Information

When plural computers have duplications of objects and edit them independently (that is simultaneous-editing-work), it is hard to assume all edits by all computers are always valid. Some edits might be judged non-valid. Step-4 0106 of FIG. 1 can include a sub-step of judging validity of order-information. Only valid order-information can be used for changing the reference.

Details of this mechanism is discussed in Section of 3.1 (“Updating DB by concurrent editing works”) of U.S. application Ser. No. 12/688,854, which is a basis of continuation-in-part. Validity of order-information can be judged according to a criterion that was given beforehand. Step-4 will be performed if the order-information is valid.

### (3) Algorithm to get Next-Destination-Object

There are many ways to use the order-information for getting next-destination-object. The simple way is that the order-information directly indicates the new object. For example, order-information is an address of next-destination-object, a label assigned to it, a number assigned to it, a list of labels assigned to it (as shown by U.S. Pat. No. 6,526,455), or any other data identifying it.

Another way is to use an algorithm to get next-destination-object.

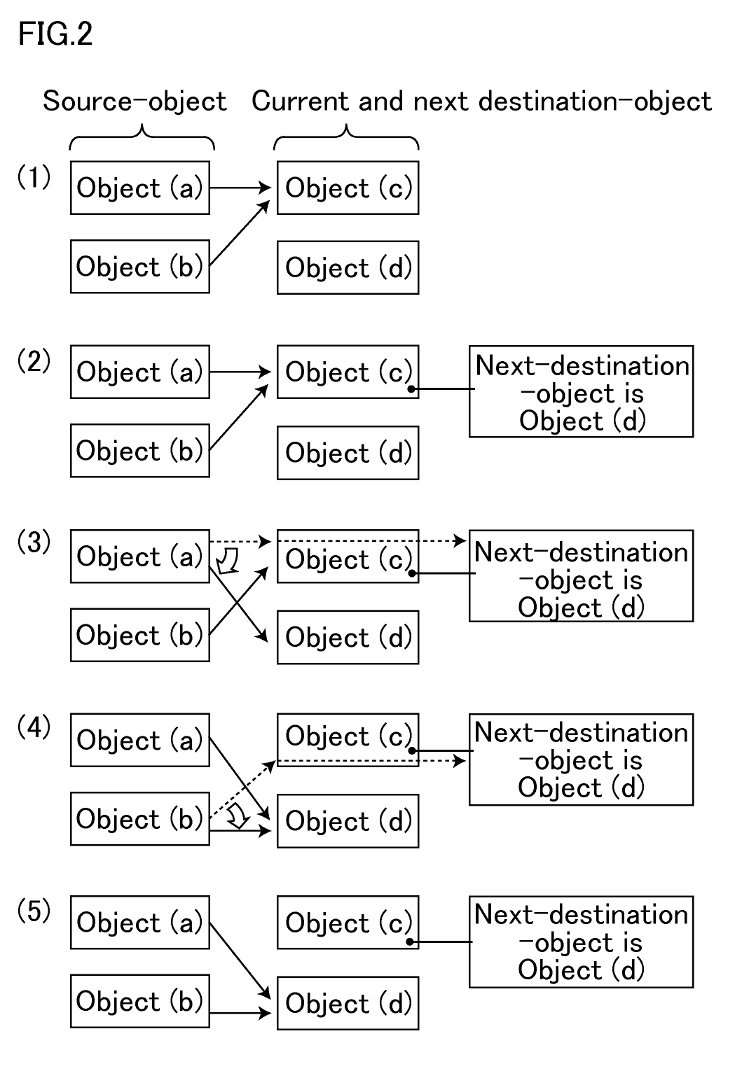

An example is “Changing reference logic” of Main Table A of FIG. 2 of U.S. application Ser. No. 12/688,854, which is a basis of continuation-in-part. Here, labels of current-destination-objects are analyzed for getting next-destination-objects.

Another example is a procedure using the reference changing tree of FIG. 3 of U.S. application Ser. No. 12/688,854, which is a continuation-in-part basis of this application. Here, nodes assigned to current-destination-objects are order-information. Next-destination-objects are determined by these nodes and the tree structure.

### (4) Sub-Steps of Step-4

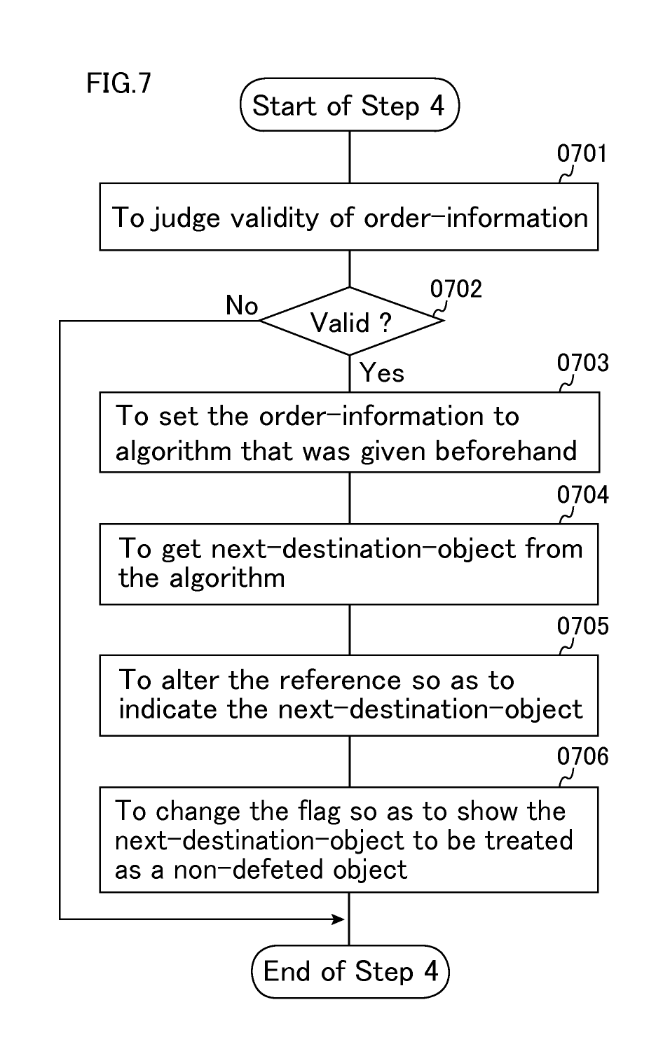

FIG. 7 shows sub-steps of step-4 implementing these mechanisms (that are (1), (2) and (3) mentioned above). First, the validity of the order-information is judged 0701. If it is judged as non-valid 0702, the Step-4 will terminate. Next, the order-information is set to an algorithm that was given beforehand 0703, in order to get the next-destination-object 0704. And, the reference is changed so as to indicate the next-destination-object 0705. Finally, the flag is changed so as to show the next-destination-object to be treated as a non-deleted object 0706.

I claim;

1. An apparatus for handling computer-objects that are collections of information contained in single or plural memory devices, comprising:
a memory device containing a source-object that is a computer-object associated with a reference indicating a current-destination-object that is a computer-object,
said device or another device containing an order-information that is information expressing an order to alter said reference so as to indicate next-destination-object that is a computer-object, and
that is associated with said current-destination-object, and
a means of performing a procedure containing the following steps,
(Step-1) a step of accessing said source-object and said reference,
(Step-2) a step of accessing said current-destination-object,
(Step-3) a step of accessing said order-information, and
(Step-4) a step of altering said reference so as to indicate said next-destination-object, according to said order-information.

2. An apparatus according to claim 1, further comprising
a means of setting association between an order-information and a current-destination-object.

3. A method for handling computer-objects that are collections of information contained in single or plural memory devices, comprising the following sequence of steps,
(Step-1) a step of accessing a source-object that is a computer-object associated with a reference indicating a current-destination-object that is a computer-object,
(Step-2) a step of accessing said current-destination-object,
(Step-3) a step of accessing an order-information that is information expressing an order to alter said reference so as to indicate next-destination-object that is a computer-object, and
that is associated with said current-destination-object, and
(Step-4) a step of altering said reference so as to indicate said next-destination-object, according to said order-information.

4. A method according to claim 3, in which
if said next-destination-object is associated with a flag showing that said next-destination-object is treated as a deleted object, said flag is changed at Step-4 so that said next-destination-object is treated as a non-deleted object.

5. A method according to claim 3, in which
validity of said order-information is judged according to a criterion that was given beforehand, and Step-4 is performed if said order-information is valid.

6. A method according to claim 3, in which
said next-destination-object is obtained from order-information by an algorithm that was given beforehand.
